(19) United States
(12) Patent Application Publication
(10) Pub. No.: US 2026/0135760 A1
(43) Pub. Date: May 14, 2026

(54) COMMUNICATION DEVICES AND METHODS FOR COPYING MODEL(S) IN AL/ML FOR AIR INTERFACE

(71) Applicant: SHENZHEN TCL NEW TECHNOLOGY CO., LTD., Shenzhen, Guangdong (CN)

(72) Inventor: Junrong GU, Shenzhen, Guangdong (CN)

(73) Assignee: SHENZHEN TCL NEW TECHNOLOGY CO., LTD., Shenzhen, Guangdong (CN)

(21) Appl. No.: 19/121,781

(22) PCT Filed: Nov. 7, 2022
(86) PCT No.: PCT/CN2022/130244

§ 371 Date: Apr. 16, 2025

(51) Int. Cl. H04L 41/084

(52) U.S. Cl. CPC H04L 41/0846

(57) ABSTRACT

A method for copying model(s) in artificial intelligence (AI)/machine learning (ML) for air interface by at a first node includes detecting a signaling configured by a second node, wherein the signaling is associated with an AI/ML model copy, copying an AI/ML model based on the signaling, and reporting a copied/duplicated AI/ML model base on the signaling.

### BACKGROUND OF DISCLOSURE

### 1. Field of the Disclosure

The present disclosure relates to the field of wireless communication systems, and more particularly, to communication devices and methods for copying model(s) in artificial intelligence (AI)/machine learning (ML) for air interface, for example, the present disclosure is related to the new study item description (SID) on AI/ML for new radio (NR) air interface of the Release 18, which is established in 3rd generation partnership project (3GPP) radio access network (RAN) plenary meetings 94e in December 2022. The discussion is led by RAN1 and begins in May 2022. Particularly, the present disclosure covers one-sided model and two-sided models.

### 2. Description of the Related Art

At the RAN1 94 meeting, ML is introduced to enhance the performance of physical (PHY) layer (or called first layer (L1 layer)). Three use cases are agreed to study. They are respectively an enhanced channel state information (CSI) feedback, a beam prediction, and a positioning. Generally, a framework is needed for all these use cases.

The following agreement is achieved in the RAN1 110b-e meeting: For model selection, activation, deactivation, switching, and fallback at least for UE sided models and two-sided models, study the following mechanisms: 1. Decision by the network comprises network-initiated and UE-initiated, requested to the network. 2. Decision by the UE includes event-triggered as configured by the network, UE's decision is reported to network, UE-autonomous, UE's decision is reported to the network, and UE-autonomous, UE's decision is not reported to the network. Network sided models and other mechanisms are for further study (FFS).

From above, there are several actions/operations defined. Thus, during these operations, model copying is needed to facilitate these operations. The model copying is needed in the actions not listed here, such as model deployment. A model can be trained at a node then copied and delivered to the UE and deployed.

Moreover, the following agreement are also from RAN1 110b-e meeting. It is mainly about an ML model ID. The model ID may be introduced. Agreement: Study LCM procedure on the basis that an AI/ML model has a model ID with associated information and/or model functionality at least for some AI/ML operations. FFS: Detailed discussion of model ID with associated information and/or model functionality. FFS: usage of model ID with associated information and/or model functionality based LCM procedure. FFS: whether support of model ID. FFS: the detailed applicable AI/ML operations.

There can be conflicts between some of the operations of an ML model. One of the issues is mentioned as follows. That is the “interruption of AI/ML model inference due to model update”. If an ML model is updated, it cannot perform inference at the same time. Thus, the inference is interrupted by model update because the model updating updates all the ML models, parts of the ML models or a backbone of ML models. There are few prior arts currently in the 3GPP.

Therefore, there is a need for communication devices and methods for machine learning (ML) model monitoring, which can solve the issues in the prior art, provide model allocation and delivery, reduce overhead, provide a good communication performance, and/or provide high reliability.

### SUMMARY

An object of the present disclosure is to propose communication devices and methods for copying model(s) in artificial intelligence (AI)/machine learning (ML) for air interface, which can solve the issues in the prior art, provide model allocation and delivery, reduce overhead, provide a good communication performance, and/or provide high reliability.

In a first aspect of the present disclosure, a method for copying model(s) in artificial intelligence (AI)/machine learning (ML) for air interface by a first node includes detecting a signaling configured by a second node, wherein the signaling is associated with copying at least an AI/ML model, copying an AI/ML model based on the signaling, and reporting a copied/duplicated AI/ML model base on the signaling.

In a second aspect of the present disclosure, a first node comprises a memory, a transceiver, and a processor coupled to the memory and the transceiver. The processor is configured to execute the above method.

In a third aspect of the present disclosure, a method for copying model(s) in artificial intelligence (AI)/machine learning (ML) for air interface performed by a second node includes configuring a signaling to a first node, wherein the signaling is associated with copying at least an AI/ML model, controlling the first node to copy an AI/ML model based on the signaling, and controlling the first node to report a copied/duplicated AI/ML model base on the signaling.

In a fourth aspect of the present disclosure, a second node comprises a memory, a transceiver, and a processor coupled to the memory and the transceiver. The processor is configured to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a basic auto-encoder model for enhanced CSI feedback according to an embodiment of the present disclosure.

FIG. 2 is a block diagram of nodes of communication in a communication network system according to an embodiment of the present disclosure.

FIG. 3 is a flowchart illustrating a method for a model copy in artificial intelligence (AI)/machine learning (ML) for air interface performed by a first node according to an embodiment of the present disclosure.

FIG. 4 is a flowchart illustrating a method for a model copy in artificial intelligence (AI)/machine learning (ML) for air interface performed by a second node according to an embodiment of the present disclosure.

FIG. 5 is a schematic diagram illustrating an example of a basic auto-encoder model for enhanced CSI feedback according to an embodiment of the present disclosure.

FIG. 6 is a schematic diagram illustrating an example of a functional framework of RAN intelligence according to an embodiment of the present disclosure.

FIG. 7 is a block diagram of a general framework for ML/AI for NR air interface according to an embodiment of the present disclosure.

FIG. 8 is a flowchart illustrating the report of copied ML model according to an embodiment of the present disclosure.

FIG. 9 is a flowchart illustrating that the CSI generation part is copied, and the paired model is delivered to a third node according to an embodiment of the present disclosure.

FIG. 10 is a flowchart illustrating that the CSI generation part is copied, and the paired model is delivered to a third node by a UE according to an embodiment of the present disclosure.

FIG. 11 is a block diagram of a communication device such as UE according to an embodiment of the present disclosure.

FIG. 12 is a block diagram of a communication device such as gNB according to an embodiment of the present disclosure.

FIG. 13 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The AI/ML is introduced into a physical (PHY) layer and a medium access control (MAC) layer, to enhance the system performance. Several use cases are decided to be studied in 3GPP RAN1. They are respectively the CSI feedback compression, the beam management, and the positioning. The ML models can be trained either online or offline.

For a machine learning model, it should be trained at first. The training can be performed by a node, which can be a gNB, a UE, or a third node. The training can be online training or offline training. After the ML model is trained, it will be deployed. For enhance CSI feedback, the ML model is a two-sided model, which will be deploy at a UE and a gNB, respectively. The CSI models will be monitored to see whether is works properly.

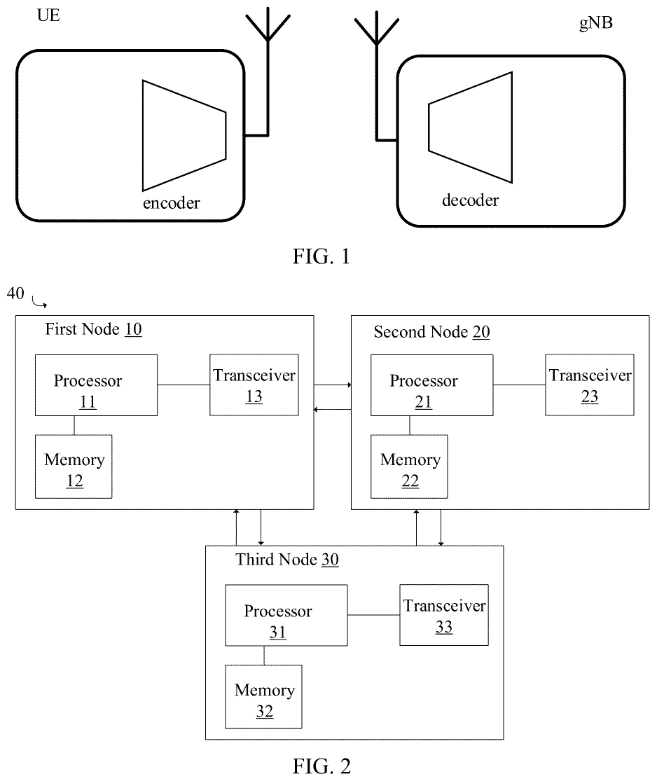

Some embodiments of the present disclosure discuss mechanisms for copying model(s) in AI/ML for air interface. FIG. 1 is a schematic diagram illustrating an example of a basic auto-encoder model for enhanced CSI feedback according to an embodiment of the present disclosure. FIG. 1 illustrates that, in some embodiments, a basic model of auto-encoder is shown as follows. The encoder compressed the raw CSI-RS values (in short, raw CSI)/maximum Eigen vector and reports its output to the gNB. The gNB will decompress it. A new CSI report is the CSI report that contains the enhanced CSI feedback by an AI/ML model.

At the UE, the input is compressed and output to the channel. The input of the encoder can be either (maximum) Eigen vectors or channel matrix. The compressed output is the input to the decoder and reconstructed at the gNB side. Several type of ML models of training ML methods are discussed include training at UE side and delivering the ML model to gNB; training at gNB side and delivering the model to the UE; joint training by both UE and gNB, separate training at UE and gNB. Some embodiments of the present disclosure mainly discuss joint training by both UE and gNB.

FIG. 2 illustrates that, in some embodiments, at least one first node 10 such as at least one user equipment (UE), and a second node 20 such as base station (e.g., gNB) 20, and at least one first node 30 such as at least one user equipment (UE) or other communication device for communication in a communication network system 40 according to an embodiment of the present disclosure are provided. The communication network system 40 includes at least one first node 10 such as at least one user equipment (UE), and a second node 20 such as base station (e.g., gNB) 20, and at least one first node 30 such as at least one user equipment (UE) or other communication device. The at least one first node 10 may include a memory 12, a transceiver 13, and a processor 11 coupled to the memory 12 and the transceiver 13. The at least second first node 20 may include a memory 22, a transceiver 23, and a processor 21 coupled to the memory 22 and the transceiver 23. The at least one third node 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

In some embodiments, the processor 11 is configured to detect a signaling configured by the second node 20, wherein the signaling is associated with copying at least an AI/ML model, the processor 11 is configured to copy an AI/ML model based on the signaling, and the transceiver 13 is configured to report a copied/duplicated AI/ML model base on the signaling. This can solve the issues in the prior art, provide model allocation and delivery, reduce overhead, provide a good communication performance, and/or provide high reliability.

In some embodiments, the processor 21 is configured to configure a signaling to the first node 10, wherein the signaling is associated with copying at least an AI/ML model, the processor 21 is configured to control the first node 10 to copy an AI/ML model based on the signaling, and the processor 21 is configured to control the first node 10 report a copied/duplicated AI/ML model base on the signaling. This can solve the issues in the prior art, provide model allocation and delivery, reduce overhead, provide a good communication performance, and/or provide high reliability.

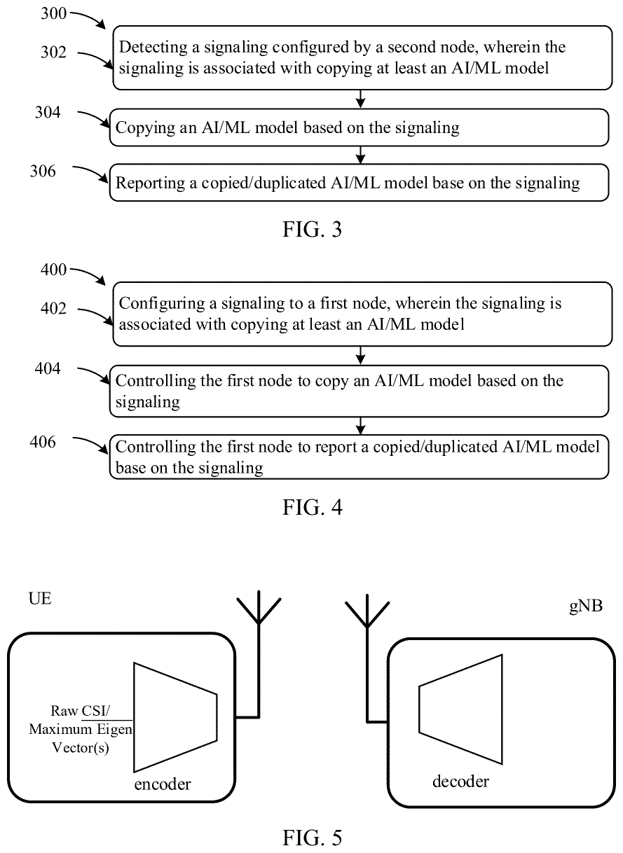

FIG. 3 illustrates a method 300 for a method for a model copy in artificial intelligence (AI)/machine learning (ML) for air interface by at least one first node (such as UE) according to an embodiment of the present disclosure. In some embodiments, the method 300 includes: a block 302, detecting a signaling configured by a second node, wherein the signaling is associated with copying at least an AI/ML model, a block 304, copying an AI/ML model based on the signaling, and a block 306, reporting a copied/duplicated AI/ML model base on the signaling. This can solve the issues in the prior art, provide model allocation and delivery, reduce overhead, provide a good communication performance, and/or provide high reliability.

FIG. 4 illustrates a method 400 for a method for a model copy in artificial intelligence (AI)/machine learning (ML) for air interface performed by a second node (such as gNB) according to an embodiment of the present disclosure. In some embodiments, the method 400 includes: a block 402, configuring a signaling to a first node, wherein the signaling is associated with copying at least an AI/ML model, a block 404, controlling the first node to copy an AI/ML model based on the signaling, and a block 406, controlling the first node to report a copied/duplicated AI/ML model base on the signaling. This can solve the issues in the prior art, provide model allocation and delivery, reduce overhead, provide a good communication performance, and/or provide high reliability.

FIG. 5 is a schematic diagram illustrating an example of a basic auto-encoder model for enhanced CSI feedback according to an embodiment of the present disclosure. FIG. 5 illustrates that, in some embodiments, a basic model of auto-encoder is shown as follows. The encoder compressed the raw CSI-RS values (in short, raw CSI)/maximum Eigen vector and reports its output to the gNB. The gNB will decompress it. A new CSI report is the CSI report that contains the enhanced CSI feedback by an AI/ML model.

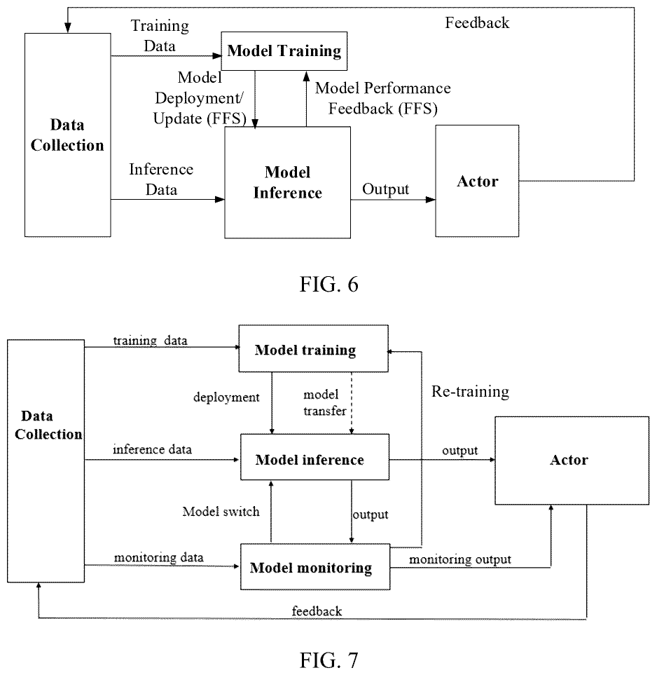

FIG. 6 is a schematic diagram illustrating an example of a functional framework of RAN intelligence according to an embodiment of the present disclosure. FIG. 6 illustrates that, in some embodiments, the ML models need to be monitored during model inference. A functional framework of RAN intelligence is provided in RAN3. It can be further modified for RAN1. The ML Model will be monitored after deployment to check whether it works properly. Usually, the ML model performance is compared to criterion. If the ML model does not work properly. The UE will switch to another ML model, or fallback to the non-AI working way. The ML model being monitored will be retrained.

In some examples, the general framework including the model monitoring is given as FIG. 7. The model monitoring is added in compared with FIG. 6. The model monitoring can trigger re-training of an ML model. In this example, the model monitoring can trigger some actions, such model updating, model activation, model deactivation fallback and so on. They are performed by the actor. In another example, there is no connection between the actor and the model monitoring in FIG. 7. The actor only performs the action indicated by model inference.

In some embodiments of this disclosure, a method is provided to copy the ML model(s) in an entity. The model copy benefits the fine tuning and the model management and training. The related signalings are designed. The allocation of model ID is provided, and the copying of multiple models are given. The model copy with gNB/UE to deliver the copied model is provided. At least the copy information such as time and/or tuning version is added into the model ID. It is necessary to copy an ML model, and deliver it to the target node if needed, for model training, for model generalization, deployment, etc. The copied model can be delivered to another UE in vicinity. It would reduce the tuning overhead of this UE or deploy and activate the copied model directly. Invention effect of some embodiments of this disclosure may include at least one of the followings: 1. The problem of model allocation is solved. Especially for the model ID allocation. 2. The problem of model delivery is solved with a model copying. To reduce the overhead, in some embodiments, only the ID of the copied model is delivered to reduce the overhead of model delivery.

### Embodiment 1: Signaling Design

For an ML model (part), the ML model can be at first deployed at the UE side. The ML model (part) can be processed for example, fine-tuned, pre-processed, and/or post-processed. The ML model (part) has changed for example, regarding model parameters, model structure, or part of the model parameters and part of model structures, for example, a backbone of the ML model. In this way, the model becomes different with the model when it is deployed.

Whether the ML model can be copied is a model attribute or a model description. It is configurable by gNB. For example, {1} means that the ML model can be copied, {0} means that the ML model cannot be copied. By default, the copying of {complete, part or structure or parameter} of an ML model are not copiable or allowed. As an alternative, by default, the copying of one of {complete, part or structure or parameter} of an ML model is copiable or allowed, the others are not.

In some examples, the signaling to configure for copying model(s) for a UE is an RRC signaling, MAC-CE, and/or DCI. It is a one-bit field. By default, the copying of {complete, part or structure or parameter} of an ML model is not copiable or allowed. As an alternative, by default, the copying of one of {complete, part or structure or parameter} of an ML model is copiable or allowed, the others are not.

In some examples, the signaling to configure for copying model(s) for a UE is an RRC signaling, MAC-CE, and/or DCI. {00} means that copy the complete model (part). {01} means that copy the parameters only. {10} means that copy the model structures. {11} means that copy the backbone of an ML model. By default, if the bits are not configured, it is the copying of complete ML model (part).

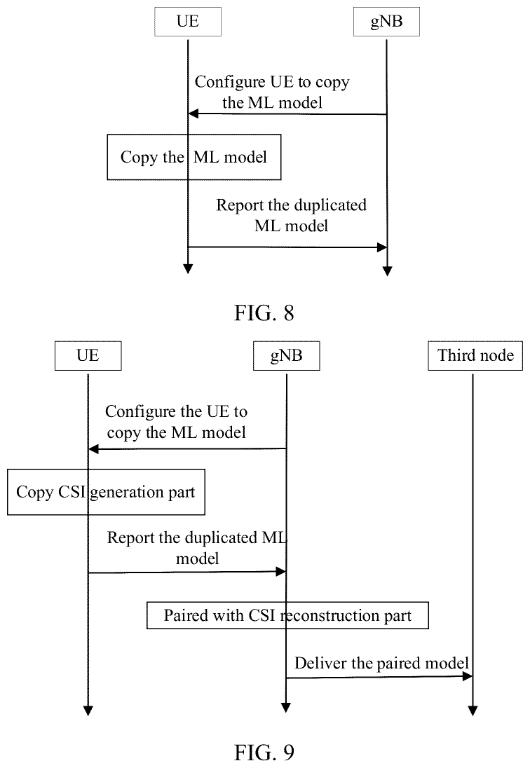

FIG. 8 is a flowchart illustrating the report of copied ML model according to an embodiment of the present disclosure. The “copy the ML model” signaling contains the copied model ID and indicating how to copy the ML model. In some examples, the UE would report the copied/duplicated ML model according to the configuration signaling. The UE reports the complete model, the parameters only, the model structures, or the backbones. In some examples, the gNB configures a third node (a UE, an OTT server, or another gNB) to copy an ML model (part). The copying node is not necessarily a UE.

In some examples, the Model ID is configured by gNB. For example, a new model ID is sent to UE in the model copy signaling. This new model ID is for the new copied model.

In some examples, the model ID is generated by UE. The copied model is generated with model ID, with a pre-fix, or post-fix to the original ML model. For example, the original model ID is “xxxxxx”, and copied ML model is “xxxxxx_copy001”, or “copy001_xxxxxx”.

In some examples, the model ID is configured by gNB and generated by UE. For example, the “xxxxxx” is configured by gNB and the UE adds pre-fix or post-fix. For example, the gNB configures the ID” as “yyyyyy”, such that the ID of the copied model would be “yyyyyy_copy001” or “copy001_yyyyyy”.

In another way, the copied model ID is in a certain range. For example, when “xxxxxx” is greater than “100000”, the model ID is reserved for the copied model.

In some examples, the “copy” in model ID indicates that the model is a copy or the original model. Other indication is not precluded, such as “C”, “Dup” (for duplication).

### Model Format:

In some examples, the model is copied model following the format of the original model being copied. In some examples, this is a default setting, if the format of the copied model is not configured. In some examples, the formation of copied model is indicated in the copying signaling, such as ONNX, h5, or runtime image et.al.

### Embodiment 2: Multiple Models

A UE is capable of support multiple ML models. The gNB configures the UE to copy multiple ML models, with a single signaling at a time. The configuration signaling indicating model copying comprises the model ID of the ML models to be copied, such as {Model ID1 of model 1, Model ID 2 of model 2, Model ID 3 of model 3, . . . }. Similar to the first embodiment, the signaling can be a RRC signaling, MAC-CE, or DCI.

In some examples, the configuration signaling indicating model copying comprises the model ID of the ML models to be copied, and the copied model ID such as {Model ID1 of model 1, Model ID 2 of model 2, Model ID 3 of model 3, . . . , Model ID11 of copied model, Model ID 21 of copied model, Model ID 31 of copied model}.

In some examples, the configuration signaling indicating model copying comprises the model ID of the ML models to be copied, and the copied model ID such as {Model ID 1of model 1, Model ID 1 of copied model, Model ID 2 of copied model, Model ID 3 of copied model}.

In some examples, there is only one ID of the original model, and it may be copied multiple times for each copied model ID such as {Model ID of model 1, Model ID 1 of copied model, Model ID 2 of copied model, Model ID 3 of copied model}. Model ID 1 of copied model, Model ID 2 of copied model, and Model ID 3 of copied model are just three model IDs. They are linked to the same copied ML model.

As an example, the {Model ID of model 1, Model ID 1 of copied model, Model ID 2 of copied model, Model ID 3 of copied model} is provided. Model ID 1 of copied model, Model ID 2 of copied model, and Model ID 3 of copied model are three model IDs. They are linked to the three copies of the original ML model. The model can be copied at three different time instances.

As an example, the signaling is a broadcast-like signaling for a plurality of UEs. Each UE would copy its ML model. The broadcast-like signaling can be a DCI, RS, MAC-CE, and RRC signaling.

### Embodiment 3: Two-sided Model with Model Delivery by a gNB

For two-sided model, the model part can be copied with above method. Since the two-sided model works in a pair, it can be copied with either by a part or by a pair. A third node can be an OTT (over the top server) or another gNB or another UE.

FIG. 9 is a flowchart illustrating that the CSI generation part is copied, and the paired model is delivered to a third node according to an embodiment of the present disclosure. FIG. 9 illustrates that, in some embodiments, the following steps are performed. 1. At first, the ML model is under inference at UE side. 2. The ML model is configured to be copied by UE. A new model ID for the copied model is configured to the UE by the gNB. 3. The model is copied by the UE. 4. UE reports the completion of model copying to the gNB with PUCCH or PUSCH. 5. The gNB configures the fine tuning of the new copied model. The configuration contains the ML model ID to denotes the specific ML model. 6. The UE may perform the mode fine tuning procedures.

In some examples, the ML model is paired at the gNB. For easy management, the paired ML model has a new ID indicating the pairing relationship. For example, ID of paired ML model: {ID of CSI generation part, ID of CSI reconstruction part}.

The ID of paired ML model: {ID of CSI generation part, ID of CSI reconstruction part} is delivered to the third node together with the paired ML model.

As an alternative, the only the CSI generation part is copied, and the ID Paired ML model: {ID of CSI generation part, ID of CSI reconstruction part} is deliver with the CSI generation part to a third node. As an example, this copying method is related to one CSI reconstruction part that is paired with multiple CSI generation part. The generation part copied together with the pairing information are delivered to a third note.

As an alternative, the only the CSI reconstruction part is copied, and the ID of Paired ML model: {ID of CSI generation part, ID of CSI reconstruction part} is deliver with the CSI reconstruction part to a third node. As an example, this copying method is related to one CSI generation part that is paired with multiple CSI reconstruction parts. The reconstruction part copied together with the pairing information are delivered to a third note.

### Embodiment 4: Two-sided Mode with Model Delivery by a UE

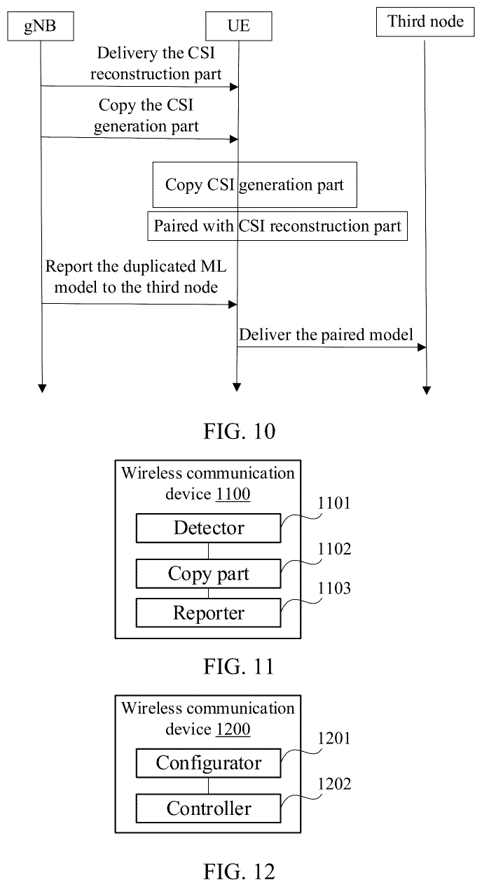

FIG. 10 is a flowchart illustrating that the CSI generation part is copied, and the paired model is delivered to a third node by a UE according to an embodiment of the present disclosure. FIG. 10 illustrates that, in some embodiments, the following steps are performed. 1. At first the ML model is under inference at UE side. 2. The ML model is configured to be copied by UE. A new model ID for the copied model is configured to the UE by the gNB. 3. The model is copied by the UE. 4. UE reports the completion of model copying and delivers the copied model to gNB with PUCCH or PUSCH. 5. The gNB performs fine tuning of the new copied model. 6. The gNB delivers the copied model to the UE. 7. The gNB triggers model switching. The trigger signal is RRC signaling, MAC-CE, or DCI. The model switching signaling contains the model ID of the ML model to be replaced, and the model ID to be switching to.

In some examples, the ML model is paired at the gNB. For easy management, the paired ML model has a new ID indicating the pairing relationship.

ID of Paired ML model: {ID of CSI generation part, ID of CSI reconstruction part}.

The ID of Paired ML model: {ID of CSI generation part, ID of CSI reconstruction part} is delivered to the third node together with the paired ML model.

As an alternative, the only the CSI generation part is copied, and the ID paired ML model: {ID of CSI generation part, ID of CSI reconstruction part} is deliver with the CSI generation part to a third node. As an example, this copying method is related to one CSI reconstruction part and is paired with multiple CSI generation part. The generation part copied together with the pairing information are delivered to a third note.

As an alternative, the only the CSI reconstruction part is copied, and the ID of paired ML model: {ID of CSI generation part, ID of CSI reconstruction part} is deliver with the CSI reconstruction part to a third node. As an example, this copying method is related to one CSI generation part and is paired with multiple CSI reconstruction part. The reconstruction part is copied and together with the pairing information are delivered to a third note.

### Embodiment 5: Additional Information

In some examples, the time information is comprised in the model copying or model ID or the coped model. For example, when the model ID is generated by UE. The copied model is generated with model ID, with a pre-fix, or post-fix to the original ML model. For example, the original model ID is “xxxxxx”, and copied ML model is “xxxxxx_copy001_Oct26144000”, or “copy001_xxxxxx_Oct26144000”. In some examples, the ML model ID is signaled to gNB/UE with one Signaling. In some other examples, the ML model ID is sent to gNB/UE with multiple signaling and combine as one ID. In some examples, the time information is to link the model to system state, configuration, and the time when the data is collected. That would be easy to trace the model generation. In some examples, the time information is for system rollback or backup. In some examples, Oct26144000 indicates the model is copied at October 26 14:40:00. In some examples, the time information is not contained in the model ID, but is in the model description information. The model description denotes time when the model is copied.

In some examples, the fine tuning information is either contained in the model ID or model description information. For example, when the model ID is generated by UE. The copied model is generated with model ID, with a pre-fix, or post-fix to the original ML model. For example, the original model ID is “xxxxxx”, and copied ML model is “xxxxxx_copy001_TuningV2”, or “copy001_xxxxxx_Tuning V2.” The “TuningV2” denotes the ML model has experienced twice fine tuning. In some examples, the word “Tuning” does not necessarily exactly letter by letter, the spirit here is to indicate the action of fine tuning by a label. In some examples, the training information is either contained in the model ID or model description information. For example, when the model ID is generated by UE. The copied model is generated with model ID, with a pre-fix, or post-fix to the original ML model. For example, the original model ID is “xxxxxx”, and copied ML model is “xxxxxx_copy001_trainingV2”, or “copy001_xxxxxx_trainingV2.” The “training V2” denotes the ML model has experienced twice training. In some examples, the word “Training” does not necessarily exactly letter by letter, the spirit here is to indicate the action of training by a label. In some examples, at least one of fine-tuning information, time stamp, and training information are contained in the model ID or model description information.

FIG. 11 is a block diagram of a communication device 1100 according to an embodiment of the present disclosure. The communication device 1100 may be a first node such as a UE. The second node can be a base station. The communication device 1100 includes a detector 1101 configured to detect a signaling configured by a second node, wherein the signaling is associated with copying at least an AI/ML model, a copy part 1102 configured to copy an AI/ML model based on the signaling, and a reporter 1103 configured to reporting a copied/duplicated AI/ML model base on the signaling. This can solve the issues in the prior art, provide model allocation and delivery, reduce overhead, provide a good communication performance, and/or provide high reliability.

FIG. 12 is a block diagram of a communication device 1200 according to an embodiment of the present disclosure. The communication device 1200 may be a second node such as a base station. A first node and a third mode can a UE. The communication device 1200 includes a configurator 1201 configured to configure a signaling to a first node, wherein the signaling is associated with copying at least an AI/ML model, and a controller 1202 configured to control the first node to copy an AI/ML model based on the signaling and control the first node to report a copied/duplicated AI/ML model base on the signaling. This can solve the issues in the prior art, provide model allocation and delivery, reduce overhead, provide a good communication performance, and/or provide high reliability.

In some examples, the signaling comprises a radio resource configuration (RRC) signaling, a media access control-control element (MAC-CE), a downlink control information (DCI), or a reference signal signaling. In some examples, the signaling is a broadcast-like signaling. In some examples, by default, the signaling used to indicate copying a complete model part. In some examples, the signaling is a one-bit field or multiple bits, and the multiple bits are used to indicate copying a complete model part, copying parameters only, copying model structures, or copying a backbone of the AI/ML model. In some examples, reporting the copied/duplicated AI/ML model base on the signaling comprises reporting the complete model part, reporting the parameters only, reporting the model structures, or reporting the backbone of the AI/ML model.

In some examples, at least one of the followings is met: wherein the signaling comprises a model identifier (ID) used for the copied/duplicated AI/ML model; wherein the model ID is generated by the first node, and the copied/duplicated AI/ML model is generated with the model ID, with a pre-fix or post-fix to an original AI/ML model; wherein the model ID is configured by the second node and generated by the first node; and wherein a copied/duplicated model ID is in a certain range, and the model ID is reserved for the copied model.

In some examples, the signaling is a single signaling used to configures the first node to copy multiple AI/ML models. In some examples, the signaling comprises the model ID of the AI/ML models to be copied and the copied/duplicated model ID. In some examples, if there is only one ID of the original model, and the only one ID is copied multiple times for each copied/duplicated model ID.

In some examples, the AI/ML model is paired at the first node or the second node. In some examples, a paired AI/ML model has a new ID indicating a pairing relationship. In some examples, one or multiple (CSI) generation parts are copied at the first node and one or multiple CSI reconstruction parts are paired at the first node or the second node. In some examples, one CSI reconstruction part is paired with the multiple CSI generation parts. In some examples, the copied/duplicated AI/ML model and/or the paired AI/ML model is delivered to a third node. In some examples, the signaling, the model ID, and/or a model description information of the copied/duplicated AI/ML model comprises a fine-tuning information, a time stamp, and/or a training information. In some examples, the time information links the AI/ML model to a system state, a configuration, and a time when the model is copied, and/or the time information is used for system rollback or backup.

In summary, in some embodiments of this disclosure, a method is provided to copy the ML model(s) in an entity. The model copy benefits the fine tuning and the model management and training. The related signalings are designed. The allocation of model ID is provided, and the copying of multiple models are given. The model copy with gNB/UE to deliver the copying model is provided. At least the copy information such as time and/or tuning version is added into the model ID. It is necessary to copy an ML model, and deliver it to the target node if needed, for model training, for model generalization, deployment, etc. The copied model can be delivered to another UE in vicinity. It would reduce the tuning overhead of this UE or deploy and activate the copied model directly. Invention effect of some embodiments of this disclosure may include at least one of the followings: 1. The problem of model allocation is solved. Especially for the model ID allocation. 2. The problem of model delivery is solved with a copying model. To reduce the overhead, in some embodiments, only the ID of the copied model is delivered.

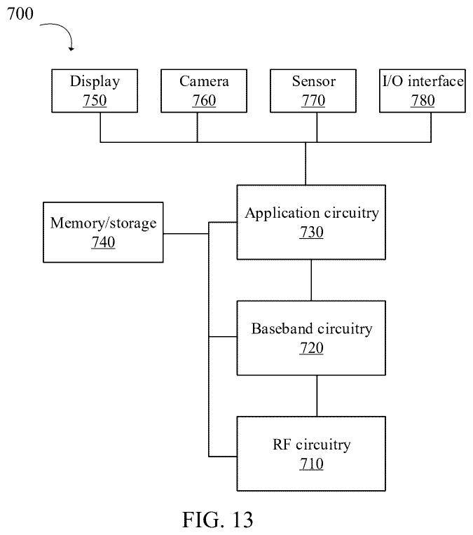

FIG. 13 is a block diagram of an example system 700 for wireless communication according to an embodiment of the present disclosure. Embodiments described herein may be implemented into the system using any suitably configured hardware and/or software. FIG. 13 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The monitoring of a ML model is not limited to a UE or a gNB. The monitoring can be performed in third node The related signaling and data need to be reported to the third node. The third node can be a UE, a gNB or a server. The methods in the embodiments apply. In this way, the signaling overhead is reduced between the gNB and the UE.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for copying model(s) in artificial intelligence (AI)/machine learning (ML) for air interface by at a first node, comprising:
detecting a signaling configured by a second node, wherein the signaling is associated with copying at least an AI/ML model;
copying an AI/ML model based on the signaling; and
reporting a copied/duplicated AI/ML model base on the signaling.

2. The method according to claim 1, wherein the signaling comprises a radio resource configuration (RRC) signaling, a media access control-control element (MAC-CE), a downlink control information (DCI), or a reference signal signaling.

3. The method according to claim 1, wherein the signaling is a broadcast-like signaling.

4. The method according to claim 1, wherein by default, the signaling used to indicate copying a complete model part.

5. The method according to claim 1, wherein the signaling is a one-bit field or multiple bits, and the multiple bits are used to indicate copying a complete model part, copying parameters only, copying model structures, or copying a backbone of the AI/ML model.

6. The method according to claim 5, wherein reporting the copied/duplicated AI/ML model base on the signaling comprises reporting the complete model part, reporting the parameters only, reporting the model structures, or reporting the backbone of the AI/ML model.

7. The method according to claim 1, wherein at least one of the followings is met:
wherein the signaling comprises a model identifier (ID) used for the copied/duplicated AI/ML model;
wherein the model ID is generated by the first node, and the copied/duplicated AI/ML model is generated with the model ID, with a pre-fix or post-fix to an original AI/ML model;
wherein the model ID is configured by the second node and generated by the first node; and
wherein a copied/duplicated model ID is in a certain range, and the model ID is reserved for the copied model.

8. The method according to claim 1, wherein the signaling is a single signaling used to configures the first node to copy multiple AI/ML models.

9. The method according to claim 8, wherein the signaling comprises the model ID of the AI/ML models to be copied and the copied/duplicated model ID.

10. The method according to claim 8 [[or 9]], wherein if there is only one ID of the original model, and the only one ID is copied multiple times for each copied/duplicated model ID.

11. The method according to claim 1, wherein the AI/ML model is paired at the first node or the second node.

12. The method according to claim 11, wherein a paired AI/ML model has a new ID indicating a pairing relationship.

13. The method according to claim 11, wherein one or multiple (CSI) generation parts are copied at the first node and one or multiple CSI reconstruction parts are paired at the first node or the second node.

14. The method according to claim 13, wherein one CSI reconstruction part is paired with the multiple CSI generation parts.

15. The method according to claim 11, wherein the copied/duplicated AI/ML model and/or the paired AI/ML model is delivered to a third node.

16. The method according to claim 7, wherein the signaling, the model ID, and/or a model description information of the copied/duplicated AI/ML model comprises a fine-tuning information, a time stamp, and/or a training information.

17. The method according to claim 16, wherein the time information links the AI/ML model to a system state, a configuration, and a time when the model is copied, and/or the time information is used for system rollback or backup.

18. A method for copying model(s) in artificial intelligence (AI)/machine learning (ML) for air interface by at a second node, comprising:
configuring a signaling to a first node, wherein the signaling is associated with copying at least an AI/ML model;
controlling the first node to copy an AI/ML model based on the signaling; and
controlling the first node to report a copied/duplicated AI/ML model base on the signaling.

19. A first node, comprising:
a memory;
a transceiver; and
a processor coupled to the memory and the transceiver;
wherein the processor is configured to execute a method for copying model(s) in artificial intelligence (AI)/machine learning (ML) for air interface, comprising:
detecting a signaling configured by a second node, wherein the signaling is associated with copying at least an AI/ML model;
copying an AI/ML model based on the signaling; and
reporting a copied/duplicated AI/ML model base on the signaling.

20. (canceled)

21. The first node according to claim 19, wherein the signaling comprises a radio resource configuration (RRC) signaling, a media access control-control element (MAC-CE), a downlink control information (DCI), or a reference signal signaling.
